(19) United States
(12) Patent Application Publication
(10) Pub. No.: US 2008/0118053 A1
(43) Pub. Date: May 22, 2008

(54) SPEAK-UP

(76) Inventors: J. Wade Beam, Chicago, IL (US); Lejla Husetovic, Lombard, IL (US)

Correspondence Address: BELL, BOYD & LLOYD, LLP, P.O. Box 1135, CHICAGO, IL, 60690, US

(21) Appl. No.: 11/562,153

(22) Filed: Nov. 21, 2006

(51) Int. Cl. H04M 1/00; H04R 1/02; H04R 1/04

(52) U.S. Cl. 379/388.01; 381/388; 381/182; 381/361

(57) ABSTRACT

The present invention is directed to a table that is constructed to receive an audio system and an audio system that is intended to be incorporated within a tabletop. The audio system comprises a housing and an audio column having a speaker wherein the audio column is capable of being retracted into the housing such that the top wall of the audio column is substantially co-planar with a tabletop. Additionally, the present invention includes a method of conducting business meetings including releasing a mechanism causing the audio column to extend out of the housing; allowing sound to travel through the speaker during the meeting and to be heard by participants in a room where the tabletop is located; and closing the audio column such that the audio column is received within the housing and the top of the audio column is at least substantially co-planar with the tabletop.

### BACKGROUND

The present invention relates generally to a speaker used for audio transmission. More particularly, the present invention relates to audio systems for use in conducting meetings and the like.

Generally, conference tables are used concurrently by multiple persons as a gathering place for information exchange. The tables are typically designed to support writing pads and utensils necessary to facilitate the exchange of information and, in most cases, are designed to support electronic devices to communicate information more efficiently. These electronic devices may include, for example, telephones, computers, monitors, speakers and various audio devices, word processors and play-back devices, as well as the wiring and connectors associated therewith.

Because modern business meetings typically require the use of several different kinds of electronic communication, meetings where multiple electronic devices are required can be problematic because the devices and wiring occupy a large portion of the table. Consequently, available work space for meeting participants is reduced and, therefore, overall meeting efficiency suffers.

Moreover, the presence of multiple electronic devices including wiring and connectors associated therewith, can detract from the overall aesthetic appearance of a space. More specifically, reducing the clutter on conference tables during meetings can not only increase communication efficiency but can also create a more aesthetically pleasing environment, which contributes to the efficiency of the meeting. As a result, there exists a need for an audio system that is designed to reduce conference room clutter in order to facilitate efficient business meetings.

### SUMMARY

The present invention generally provides tables comprising audio systems, audio systems and methods for conducting meetings. To this end, the present invention may be used, for example, for improved sound transmission, to eliminate feedback during meetings or conferences, to reduce clutter on tabletops and to provide an aesthetically pleasing tabletop when the system is not in use.

Pursuant to an embodiment of the present invention, a table is provided where the table has at least one supporting member, a tabletop having a horizontal surface and at least one opening, and an audio system that is received within the opening. The audio system includes a housing defining an interior and has a top portion and a bottom portion where the top portion defines an opening. The interior of the housing includes an audio column that is moveable to an open position, wherein at least a portion of the audio column extends out of the opening, and further includes a speaker and a top surface that is at least substantially co-planar with the horizontal surface of the tabletop when the audio column is in a closed position.

In an embodiment, the tabletop accommodates a plurality of audio systems.

In an embodiment, the audio column further comprises a microphone.

In an embodiment, the audio column further comprises a mute button.

Additionally, the audio system could be coupled to a mix-minus system.

In an embodiment, the supporting member comprises at least one table leg.

In an embodiment, the housing is removable from the table. However, in another embodiment, the housing is integral with the tabletop.

In an embodiment, the audio column comprises at least two speakers.

Pursuant to the present invention, the audio system can have a cross-sectional shape that is substantially circular.

Likewise, the audio system can have a cross-sectional shape that is substantially square.

In another embodiment of the present invention, an audio system is provided that comprises a housing defining an interior formed at least in part by side walls, a bottom wall, and a top opening. The audio column includes a speaker, has side walls, a top wall and a bottom wall and is sized to fit within the interior of the housing. The audio column is retractable within the interior of the housing between an open position, wherein at least a portion of the audio column extends through the top opening, and a closed position. The audio column further includes a guide mechanism for allowing the audio column to move between the open position and the closed position, and a releasable lock securing the audio column in the closed position.

In an embodiment, the guide mechanism comprises at least one bearing secured to the interior side walls of the housing that cooperates with a corresponding guide slot on the audio column that accommodates the bearing therein.

In an embodiment, the speaker is provided with wiring connected thereto and exiting through the bottom wall of the audio column and through the bottom wall of the housing for connection to a power source.

In another embodiment, the housing includes a gas cylinder secured to the housing and having a piston that is retractable therein between an open position and a closed position, the bottom wall of the audio column having an aperture that allows the gas cylinder to traverse the aperture as the audio column is moved between the open position and the closed position.

In an embodiment, the releasable lock includes a latch hook secured to the interior bottom wall of the housing and a cooperating latch secured to an interior side wall of the audio column. The cooperating latch releasably engages the latch hook when the audio column is in the closed position. Additionally, the cooperating latch can be spring loaded and retract from the latch hook when the audio column is sufficiently depressed so as to release the audio column and allow the audio column to move to the open position.

Pursuant to the present invention, the audio column further includes a microphone.

In an embodiment, the audio column further includes a mute button.

In an embodiment, the housing further comprises a series of bearings secured on at least two opposed interior side walls thereof that cooperate with corresponding opposed guide slots on the audio column that accommodate the bearings therein to allow vertical movement of the audio column.

In yet another embodiment of the present invention, an audio system is provided that includes a housing comprising an interior defined by side walls, a bottom wall, and having a top portion defining an opening and where the housing includes at least one member that is mountable to a portion of a tabletop. The audio system also includes an audio column comprising a speaker and being so constructed and arranged to be received within the interior of the housing and retractable between an open position and a closed position. The audio column further includes a guide mechanism comprising at least one member secured on the housing that cooperates with a corresponding guide slot on the audio column to allow vertical movement of the audio column. The audio column is releasably secured in the closed position by a releasable lock, and the audio column has a top surface that has a finish that is designed to at least substantially mimic a top surface of the tabletop.

In an embodiment, the housing further comprises a gas cylinder secured to the housing and extending upwardly therefrom, the audio column including an aperture formed in the bottom wall thereof, the aperture sized to traverse the gas cylinder.

In an embodiment, the housing includes at least a pair of opposed bearings secured to the interior side walls of the housing that cooperate with corresponding opposed guide slots on the audio column that accommodate the bearings to stabilize the audio column as the audio column moves between the open position and the closed position.

In another embodiment, the tabletop surface accommodates a plurality of audio systems mountable thereon.

In an embodiment, the audio column further comprises a microphone.

In an embodiment, the audio column further comprises a mute button.

Pursuant to the present invention, the releasable lock is formed by a latch hook secured to the interior bottom wall of the housing, and a cooperating latch secured to an interior side wall of the audio column, where the cooperating latch releasably engages the latch hook when the audio column is in the closed position.

Similarly, the cooperating latch can be spring loaded and retract from the latch hook when the audio column is sufficiently depressed so as to release the cooperating latch and allow the audio column to move to the open position.

In a still further embodiment of the present invention, a method of conducting a meeting is provided. The method comprises releasing a mechanism causing an audio column comprising a speaker to extend out of a housing thereby extending from a surface of a tabletop, allowing sound to travel through the speaker during the meeting and to be heard by participants in a room where the tabletop is located, and closing the audio column after the meeting is complete such that the audio column is caused to be received within the housing and the top of the audio column is secured in a position wherein it is at least substantially co-planar with the tabletop.

In an embodiment, the audio column of the method further comprises a microphone.

In another embodiment, the audio column of the method further comprises a mute button.

In addition, at least two audio columns may be used in the method of the present invention.

In an embodiment, the method includes connecting a telephone to the speakers. Moreover, the telephone may be used to initiate a telephone call.

An advantage of the present invention is to provide tables having improved audio systems.

A further advantage of the present invention is to provide improved audio systems.

Another advantage of the present invention is to reduce or eliminate feedback during meetings or conferences.

An additional advantage of the present invention is to replace portable speakers or speakers built into the room where meetings or conferences are held.

Moreover, an advantage of the present invention is to provide aesthetically pleasing audio systems.

Additional features and advantages are described herein, and will be apparent from, the following Detailed Description and the figures.

### BRIEF DESCRIPTION OF THE FIGURES

FIG. 1 is a perspective view showing an embodiment of a table having a plurality of audio systems and illustrating the audio columns as substantially co-planar to the tabletop when in the closed position;

FIG. 2 is a perspective view showing an embodiment of a table having a plurality of audio systems and illustrating the audio columns exposing the speaker and illustrating the relationship the audio columns bear to the tabletop when in the open position;

FIG. 3 is a perspective view showing an embodiment of the audio column in an open position exposing the speaker and illustrating a bracket used to mount the audio system to a tabletop;

FIG. 4 is a perspective view of an embodiment of the audio system showing the audio column in the closed position;

FIG. 5 is a perspective view of an embodiment of the audio system showing the audio column in the open position;

FIG. 6 is a perspective view blown apart showing an embodiment of the construction of the housing and the audio column, with the audio column in the open position;

FIG. 7 is a perspective view, partially broken away in cross section, showing an embodiment of the audio system with the audio column in the closed position and further showing the gas cylinder and the releasable lock securing the audio column in the closed position;

FIG. 8 is a perspective view showing an embodiment of the audio system with the audio column in the closed position and showing the relationship between the housing bearings and the audio column guide slot;

FIG. 9 is a side elevational view and a cross section showing an embodiment of the audio system with the audio column in the closed position and including a finished plate that is substantially co-planar with the tabletop when the audio column is in the closed position;

FIG. 10 is a side elevational view, in cross section, showing an embodiment of the audio column in an open position exposing the speaker and illustrating the relationship the audio column bears to the tabletop when in the open position.

### DETAILED DESCRIPTION

As has been indicated here and above, the present invention relates to tables, audio systems that are intended to be incorporated within a tabletop, and methods for conducting business meetings. As used in the present description, the expression “tabletop” is meant to refer to any surface that is elevated and designed to afford an individual the ability to utilize the surface for work, eating, or similar activities, including surfaces defined by tables, desks, end tables, coffee tables, or conference tables. For example, the tabletop could include a large conference table that is 40-60 feet in length and has a plurality of audio systems embedded within or mounted to the tabletop, thereby providing a conference table wherein a number of people may be seated about the periphery of the table, and have a separate audio system available for their use.

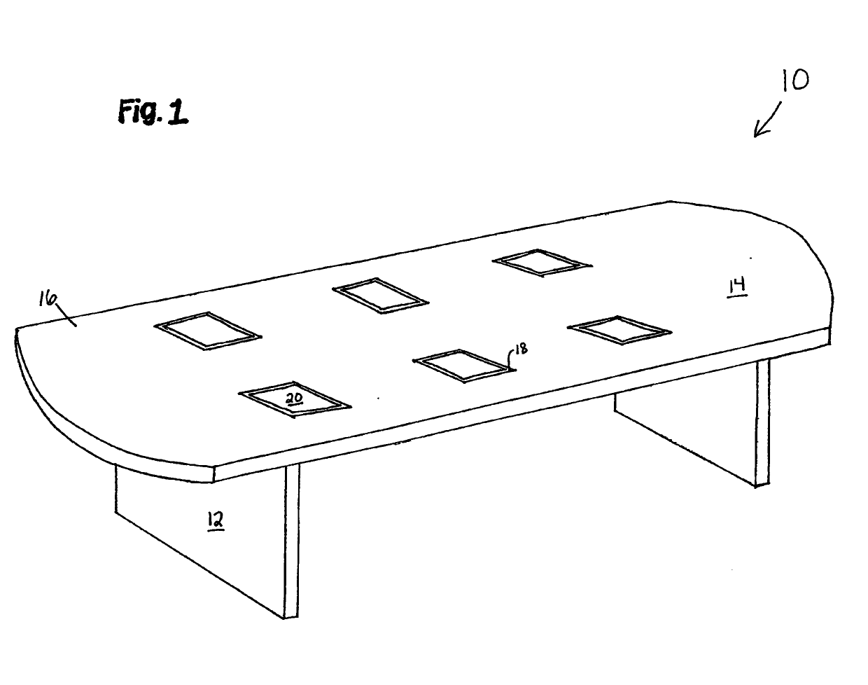

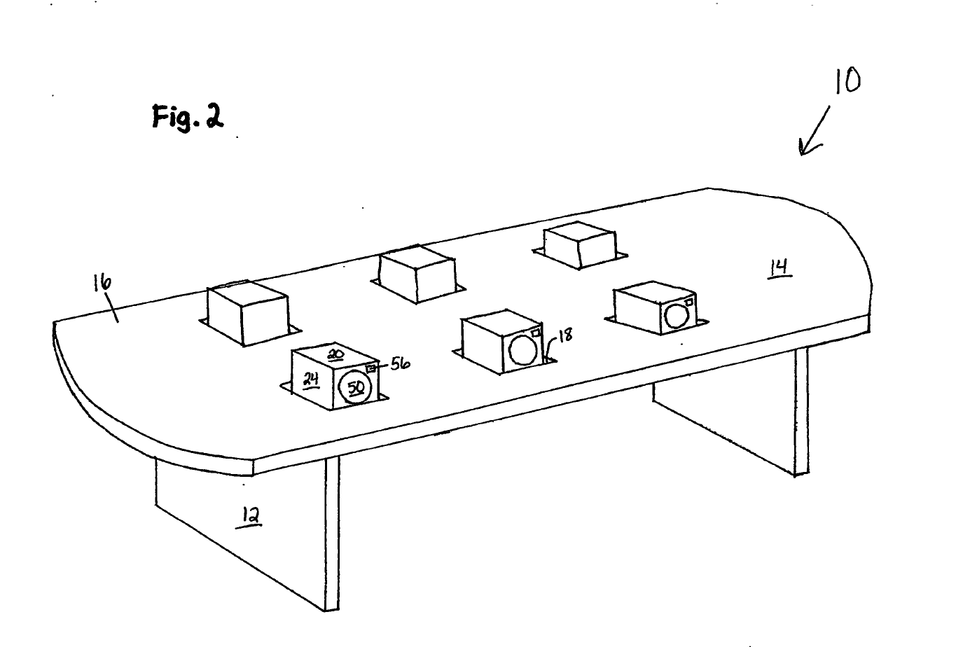

As shown in FIGS. 1 and 2, an embodiment of a table of the present invention is generally designated by the numeral 10. The table 10 includes at least one supporting member 12 and a tabletop 14 having a horizontal surface 16 and at least one opening 18. The supporting member 12 in the illustrated embodiment comprises two table legs, of course, however, any number of table legs can be used. The opening 18 assumes a substantially square cross-sectional configuration. However, while the opening 18 is shown in a substantially square cross-sectional configuration, other geometric shapes are possible. For example, the opening 18 may be substantially oval, circular, rectangular, triangular or other various geometric shapes.

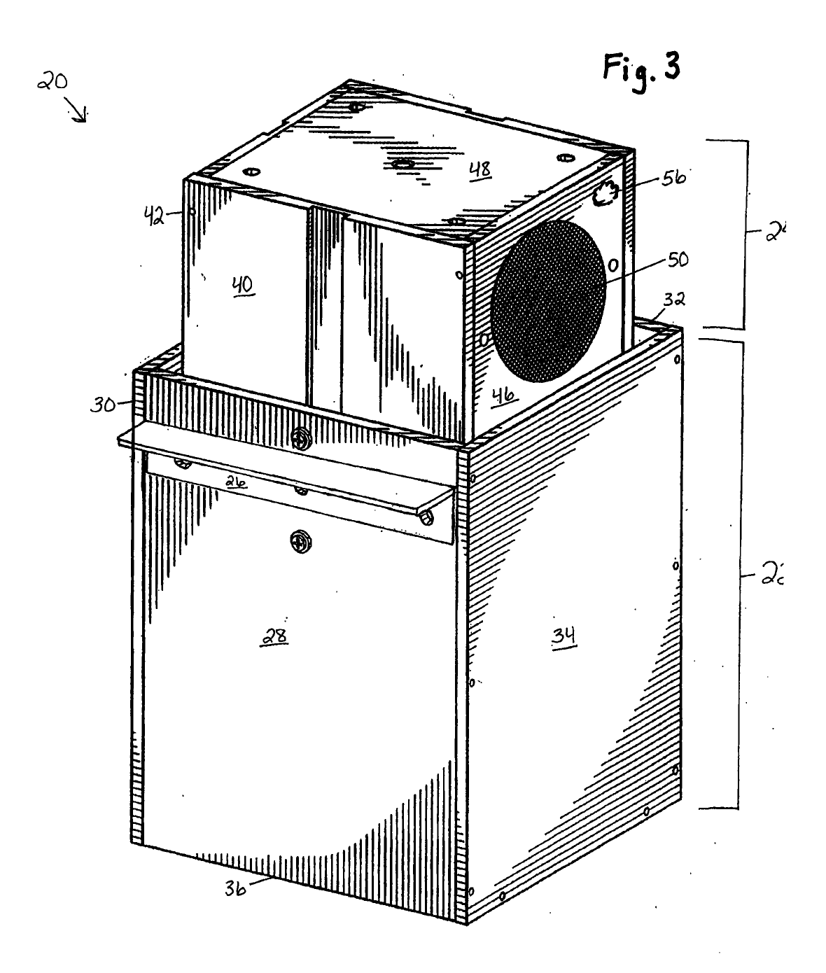

In FIGS. 1 and 2, the table 10 is shown to include a plurality of audio systems 20 received within the openings 18. As shown in FIG. 3, the audio system 20 includes a housing 22 and an audio column 24. The audio system 20 is shown to be embedded within the opening 18 of tabletop 14. In an alternative embodiment, however, the housing 22 includes at least one member that is mountable to a portion of a tabletop 14. The housing 22 may be attached to the tabletop 14 using fastening means including, but not limited to, screws, nails, nuts or bolts. For example, FIG. 3 shows a bracket 26 mounted to the housing 22 that may be used to attach the audio system 20 to a tabletop 14. The housing 22 may be removable from the tabletop 14 or integral with the tabletop 14.

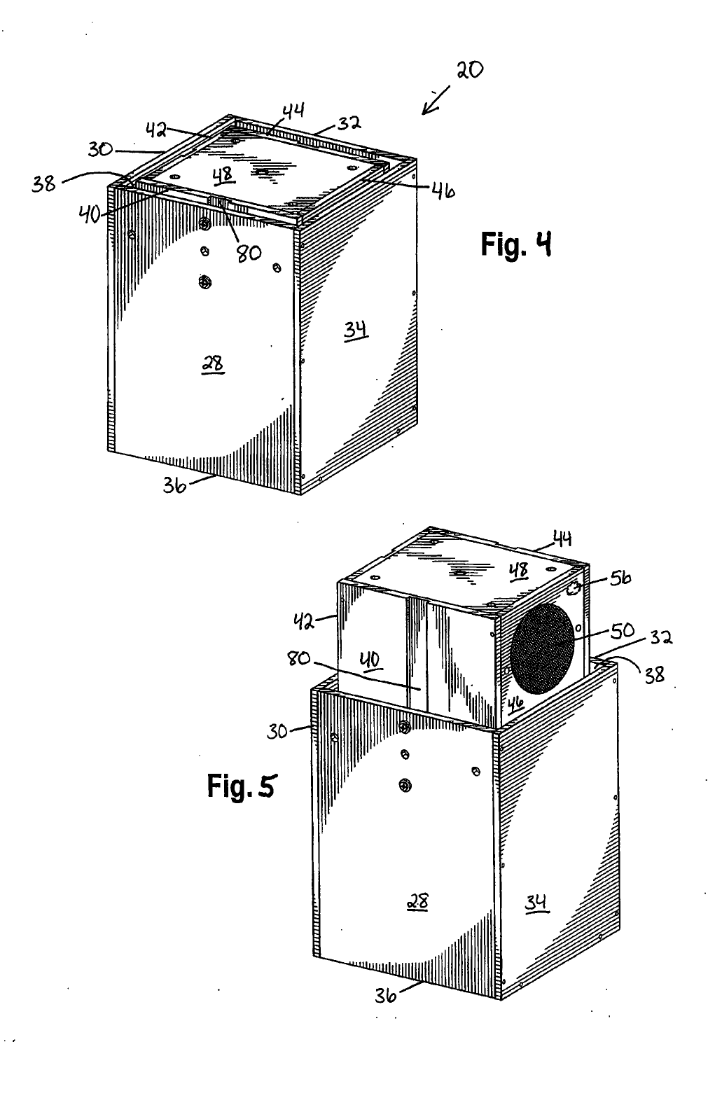

As shown in FIGS. 4 and 5, in the embodiment illustrated the housing 22 assumes a substantially square configuration formed by a series of side walls 28, 30, 32 and 34. The housing 22 defines a hollow interior 38 formed by the side walls 28, 30, 32 and 34 and a bottom wall 36. The audio column 24 is shown to have a similar geometric configuration as the housing 22, and is sized to be received within the hollow interior 38 of the housing 22. While the audio system 20 is shown in a square configuration in FIGS. 1 and 2, other geometric shapes are feasible. For example, the system could be substantially oval, circular, rectangular, triangular or other geometric shapes.

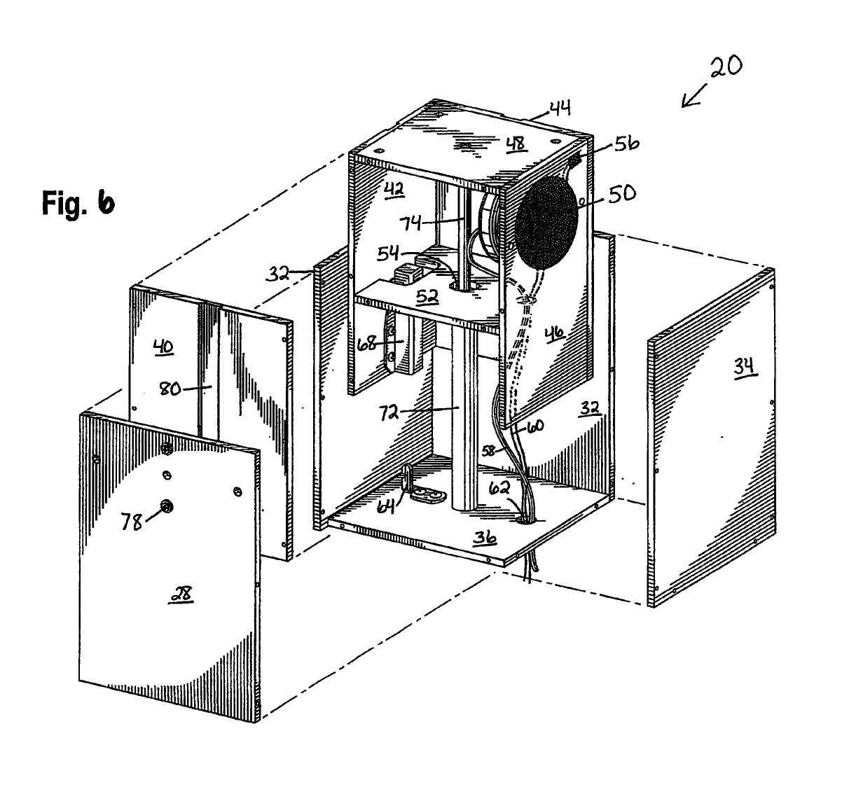

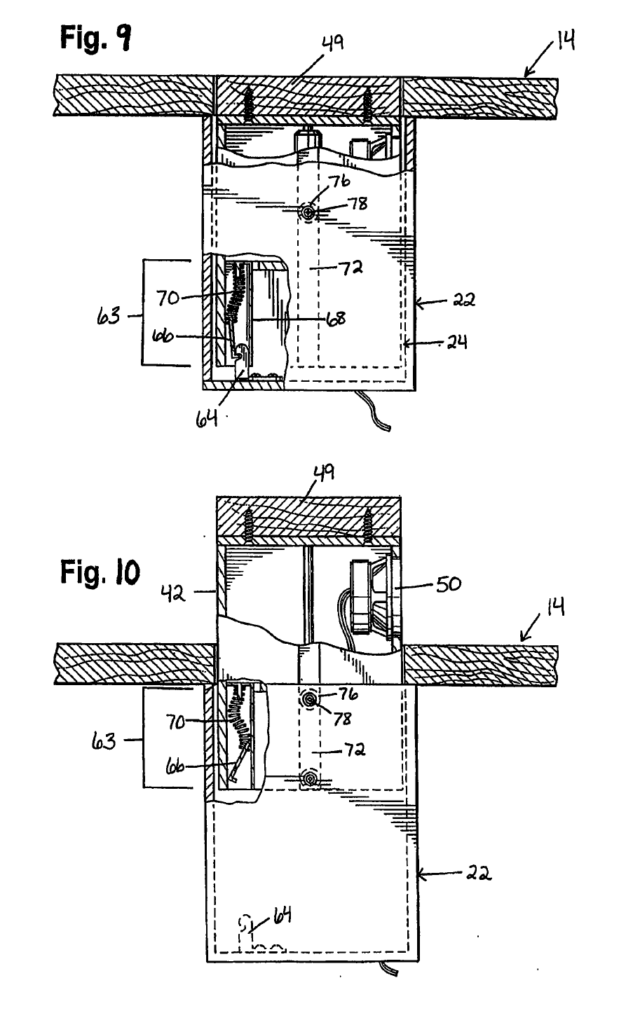

As is shown in FIGS. 4-6 of the drawings, in the embodiment illustrated the audio column is bounded by four side walls 40, 42, 44 and 46, a top wall 48 and a bottom wall 52. A side wall 46 of the audio column 24 includes a speaker 50 mounted therein. In a particular embodiment, the audio column 24 includes at least two speakers. The top wall 48 of the audio column 24 has a finish that is designed to at least substantially mimic a surface of the tabletop 14. In an alternate embodiment, the top wall 48 of the audio column 24 includes a plate 49 having a finish that at least substantially mimics a surface of the tabletop 14 and may be secured to the top wall 48 of the audio column 24 as shown in FIGS. 9 and 10. The plate 49 may be secured by fastening means including, but not limited to, screws, nails, nuts or bolts. As particularly shown in FIG. 6, the bottom wall 52 of the audio column 24 is provided with an aperture 54 to be more fully described hereinafter. The side walls, top wall and bottom walls of each of the housing 22 and audio column 24 may be manufactured and held together by an appropriate means, such as screws, nails, nuts, bolts or other fastening means.

FIGS. 2, 3, 5 and 6 of the drawings illustrate that the audio column 24 may be provided with a microphone 56. FIG. 6 further illustrates that the wiring from the speaker 50 and microphone 56, identified by numerals 58 and 60, respectively, are fed through the aperture 54 contained in the bottom wall 52 of the audio column 24. The wires 58 and 60 are then fed through an aperture 62 in the bottom wall 36 of the housing 22 and may be carried in an appropriate raceway formed on the underside of the tabletop 14 and directed to a power source. Sufficient slack is allowed in the wiring 58 and 60 in order to enable the audio column 24 to expand and retract without binding the wiring. However, while the audio column 24 is shown to be provided with a microphone 56, for example, at FIGS. 3, 5 and 6 other features may be included. For example, the audio column 24 may be provided with a mute button adjacent the speaker 50 that can be utilized to turn the speaker on and off.

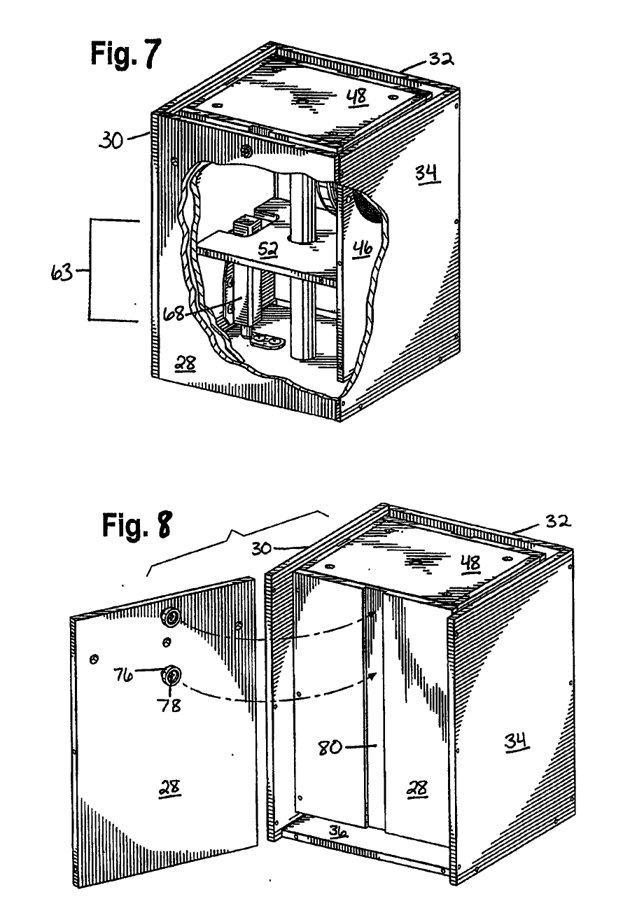

As shown in FIGS. 7, 9 and 10, the bottom wall 36 of the housing 22 can be provided with a releasable lock 63 that operates to secure the audio column 24 in the closed position. In an embodiment, the releasable lock 63 comprises a latch hook 64 secured to the interior bottom wall 36 of the housing 22 that operates in conjunction with a cooperating latch 66 that is secured to the interior side wall 42 of the audio column 24 and is carried by the audio column 24 in a manner that will be discussed further herein. FIGS. 9 and 10 show that when the audio column 24 is in the closed position, the cooperating latch 66 engages the latch hook 64 to secure the audio column 24 in the closed position. As shown in FIG. 10, the cooperating latch 66 may be induced to release itself from the latch hook 64 and allow the audio column 24 to extend upwardly into the open position exposing the microphone 56 and speaker 50.

As shown in FIGS. 6, 7 and 9 of the drawings, in order to prevent any inner mechanisms of the system from interfering with the working of the cooperating latch 66 in conjunction with the latch hook 64, a casing 68 can be provided that is mounted to the side wall 42 of the audio column 24 and encloses the cooperating latch 66. The casing 68 is constructed and arranged to receive the latch hook 64 therein when the audio column 24 is retracted to the closed position.

The cooperating latch 66 is spring loaded and includes a spring 70 which operates to cause the cooperating latch 66 to lock onto the latch hook 64 when the audio column 24 is retracted downward into the housing 22, as is shown by FIGS. 9 and 10. When further downward pressure is applied to the audio column 24, the spring 70 causes the cooperating latch 66 to disengage from the latch hook 64 in order to allow the system to move into the open position.

FIGS. 6, 7, 9 and 10 of the drawings further illustrate that in an embodiment, the housing 22 is provided with a gas cylinder 72 secured to the housing 22 that extends upwardly therefrom and is sized to fit within the aperture 54 formed in the bottom wall 52 of the audio column 24. The gas cylinder 72 houses a piston 74, which is mounted to the top wall 48 of the audio column 24. The gas cylinder 72 acts in cooperation with the piston 74 to cause the audio column 24 to expand upwardly to an open position once the cooperating latch 66 has been released from the latch hook 64. This will cause the audio column 24 to automatically rise to its fully extended open position. The system is designed so that a user need only apply minimal force in a downward direction on the top of the audio column 24 a sufficient distance to cause the cooperating latch 66 to release from the latch hook 64, at which point the gas cylinder acting in cooperating with the piston 74 will cause the audio column 24 to move upwardly into its open position. However, while the housing 22 is shown to be provided with a gas cylinder 72, for example, at FIGS. 6, 9 and 10 other components may be used to cause the audio column 24 to move upwardly into its open position. For example, the housing 22 may be provided with a hydraulic cylinder or a pneumatic cylinder.

It will be appreciated, therefore, that the gas cylinder 72 can have a dual function of stabilizing any possible side wobble of the audio column 24 relative to the housing 22 during the retraction or expansion of the system as well as providing housing for the piston 74. As indicated, the aperture 54 located on the bottom wall 52 of the audio column 24 traverses the gas cylinder 72 incident to the retraction or expansion of the audio column 24.

The housing 22 is provided with a guide mechanism for allowing the audio column 24 to move between the open position and the closed position. In an embodiment, the guide mechanism comprises at least one member secured on the housing 22 that cooperates with a corresponding guide slot 80 on the audio column 24 to allow vertical movement of the audio column 24. In an embodiment, the member comprises a bearing 76 secured to the housing.

In another embodiment and as particularly shown in FIGS. 8, 9 and 10, the guide mechanism may include at least one bearing 76 secured on the housing 22 that cooperates with a corresponding guide slot 80 on the audio column 24 that allows for vertical movement of the audio column 24 between an open and a closed position.

In a further embodiment, the housing 22 includes at least a pair of opposed bearings 76 secured to the interior side walls of the housing 22 that cooperate with corresponding guide slots 80 on the audio column 24 that accommodate the bearings 76 therein to stabilize the audio column 24 as the audio column 24 moves between the open and closed positions.

In an additional embodiment, the guide mechanism comprises a series of bearings 76 which are carried on the interior part of the housing 22 and maintained in position by screws 78. The audio column 24 is provided with an appropriate guide slot 80 that accommodates the bearings 76 therein to allow vertical movement of the audio column 24. The bearings 76 are attached by means of screws 78 to the side wall in a manner which allows the bearings 76 to rotate relative to the guide slots 80 in order to facilitate vertical movement of the audio column 24. By providing several combinations of bearings 76 and guide slots 80, the system is given a great deal of stability and can easily move into the open position or retract into the closed position without any wobble.

The present audio system 20 can be designed to incorporate a mix-minus system that is activated by sound input. When connected with an appropriate speaker system, the output sound will be automatically attenuated such that the decibel level of sound will be exactly the same at every audio system 20 in the tabletop 14 regardless of the distance between the audio system 20 and the microphone 56 from which the sound originates. It will, therefore, be appreciated that where one utilizes an extremely large conference table and a speaker at one end of the table commences speaking into a microphone, the remaining people at the table will each hear the same sound decibel regardless of the distance of that person from the individual speaking. The present audio system 20 is designed to accommodate such systems and therefore ensures that a sound attenuation is achieved around the entire tabletop 14 regardless of the size of the table 10, or the number of audio systems 20 that are embedded within the tabletop 14.

Moreover, when the output to an audio system 20 contains everything except the input from the microphone 56 located on the audio column 24 of that specific audio system 20, the amount of resulting echoes and feedback that can occur with normal audio transmission systems is drastically reduced. Therefore, the present system is specifically intended to be a superior alternative to current systems that generally have a single microphone available for a speaker at one end of the table, wherein the sound is transmitted to the personnel in the room by means of speakers usually embedded within the ceiling of the room.

Another aspect of the present invention is to provide methods of conducting meetings. For example, in an embodiment, a method of conducting a meeting comprises the steps of releasing a mechanism causing an audio column comprising a speaker to extend out of a housing thereby extending from a surface of a tabletop; allowing sound to travel through the speaker during the meeting and to be heard by participants in a room where the tabletop is located; and closing the audio column after the meeting is complete such that the audio column is caused to be received within the housing and the top of the audio column is secured in a position wherein it is at least substantially co-planar with the tabletop.

In another embodiment, the method of conducting business further includes an audio column with a microphone. Similarly, the method of conducting business could further include an audio column with a mute button. In an additional embodiment, the method includes the use of at least two audio columns. In still yet another embodiment, the method comprises a telephone connected to the speakers. Similarly, the method could also include the step of initiating a telephone call using the telephone connected to speakers.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A table comprising:
at least one supporting member;
a tabletop defining a horizontal surface and having at least one opening; and
an audio system received within the opening, the audio system comprising a housing defining an interior and having a top portion and a bottom portion, the top portion defining an opening, the interior comprising an audio column that is moveable to an open position wherein at least a portion of the audio column extends out of the opening, the audio column comprises a speaker and a top surface that is at least substantially co-planar with the horizontal surface of the tabletop when the audio column is in a closed position.

2. The table of claim 1, wherein the tabletop accommodates a plurality of audio systems.

3. The table of claim 1 wherein the audio column further comprises a microphone.

4. The table of claim 1, wherein the audio column further comprises a mute button.

5. The table of claim 1, wherein the audio system is coupled to a mix-minus system.

6. The table of claim 1, wherein the supporting member comprises at least one table leg.

7. The table of claim 1, wherein the housing is removable from the table.

8. The table of claim 1, wherein the housing is integral with the tabletop.

9. The table of claim 1, wherein the audio column comprises at least two speakers.

10. The table of claim 1, wherein the audio system has a cross-sectional shape that is substantially circular.

11. The table of claim 1, wherein the audio system has a cross-sectional shape that is substantially square.

12. An audio system comprising:
a housing defining an interior formed at least in part by side walls, a bottom wall, and a top opening;
an audio column comprising a speaker, the audio column having side walls, a top wall and a bottom wall and being sized to fit within the interior of the housing and being retractable therein between an open position, wherein at least a portion of the audio column extends through the top opening, and a closed position;
a guide mechanism for allowing the audio column to move between the open position and the closed position; and
a releasable lock securing the audio column in the closed position.

13. The audio system of claim 12, wherein the guide mechanism comprises at least one bearing secured to the interior side walls of the housing that cooperates with a corresponding guide slot on the audio column that accommodates the bearing therein.

14. The audio system of claim 12, wherein the speaker is provided with wiring connected thereto and exiting through the bottom wall of the audio column and through the bottom wall of the housing for connection to a power source.

15. The audio system of claim 12, wherein the housing comprises a gas cylinder secured to the housing and having a piston that is retractable therein between an open position and a closed position, the bottom wall of the audio column having an aperture that allows the gas cylinder to traverse the aperture as the audio column is moved between the open position and the closed position.

16. The audio system of claim 12, wherein the releasable lock comprises:
a latch hook secured to the interior bottom wall of the housing; and
a cooperating latch secured to an interior side wall of the audio column, wherein the cooperating latch releasably engages the latch hook when the audio column is in the closed position.

17. The audio system of claim 16, wherein the cooperating latch is spring loaded and retracts from the latch hook when the audio column is sufficiently depressed so as to release the audio column and allow the audio column to move to the open position.

18. The audio system of claim 12, wherein the audio column further comprises a microphone.

19. The audio system of claim 12, wherein the audio column further comprises a mute button.

20. The audio system of claim 12, wherein the housing further comprises a series of bearings secured on at least two opposed interior side walls thereof that cooperate with corresponding opposed guide slots on the audio column that accommodate the bearings therein to allow vertical movement of the audio column.

21. An audio system comprising:
a housing comprising an interior defined by side walls, a bottom wall, and having a top portion defining an opening;
the housing comprising at least one member that is mountable to a portion of a tabletop;
an audio column comprising a speaker and being so constructed and arranged to be received within the interior of the housing and retractable between an open position and a closed position;
a guide mechanism comprising at least one member secured on the housing that cooperates with a corresponding guide slot on the audio column to allow vertical movement of the audio column;
a releasable lock for releasably securing the audio column in the closed position; and
the audio column having a top surface having a finish that is designed to at least substantially mimic a top surface of the tabletop.

22. The audio system of claim 21, wherein the housing comprises a gas cylinder secured to the housing and extending upwardly therefrom, the audio column including an aperture formed in the bottom wall thereof, the aperture sized to traverse the gas cylinder.

23. The audio system of claim 21, wherein the housing includes at least a pair of opposed bearings secured to the interior side walls of the housing that cooperate with corresponding opposed guide slots on the audio column that accommodate the bearings to stabilize the audio column as the audio column moves between the open position and the closed position.

24. The audio system of claim 21, wherein the tabletop surface accommodates a plurality of audio systems mountable thereon.

25. The audio system of claim 21, wherein the audio column further comprises a microphone.

26. The audio system of claim 21, wherein the audio column further comprises a mute button.

27. The audio system of claim 21, wherein the releasable lock is formed by a latch hook secured to the interior bottom wall of the housing, and a cooperating latch secured to an interior side wall of the audio column, wherein the cooperating latch releasably engages the latch hook when the audio column is in the closed position.

28. The audio system of claim 27, wherein the cooperating latch is spring loaded and retracts from the latch hook when the audio column is sufficiently depressed so as to release the cooperating latch and allow the audio column to move to the open position.

29. A method of conducting a meeting comprising the steps of:
releasing a mechanism causing an audio column comprising a speaker to extend out of a housing thereby extending from a surface of a tabletop;
allowing sound to travel through the speaker during the meeting and to be heard by participants in a room where the tabletop is located; and
closing the audio column after the meeting is complete such that the audio column is caused to be received within the housing and the top of the audio column is secured in a position wherein it is at least substantially co-planar with the tabletop.

30. The method of claim 29, wherein the audio column further comprises a microphone.

31. The method of claim 29, wherein the audio column further comprises a mute button.

32. The method of claim 29, wherein at least two audio columns are used.

33. The method of claim 29, and further comprising connecting a telephone to the speakers.

34. The method of claim 29, and further comprising initiating a telephone call.
